(19) United States
(12) Patent Application Publication
(10) Pub. No.: US 2025/0369635 A1
(43) Pub. Date: Dec. 4, 2025

(54) CLEANROOM ARRANGEMENT AND METHOD FOR RAPIDLY PROVIDING A CLEANROOM

(71) Applicants: Fraunhofer-Gesellschaft zur Förderung der angewandten Forschung e.V., München (DE); Cellforce Group GmbH, Tübingen (DE)

(72) Inventors: Udo GOMMEL, Stuttgart (DE); Frank BÜRGER, Stuttgart (DE); Viola HOFFMANN, Stuttgart (DE); Nicolas BÜCHLE, Stuttgart (DE); Markus GRÄF, Kirchentellinsfurt (DE); Markus WOLAND, Tübingen (DE)

(21) Appl. No.: 18/875,194

(22) PCT Filed: Jun. 30, 2023
(86) PCT No.: PCT/EP2023/068010

§ 371 Date: Dec. 16, 2024

(30) Foreign Application Priority Data
Jul. 1, 2022 (DE) 10 2022 116 468.3

(51) Int. Cl. F24F 3/167; E04B 1/344

(52) U.S. Cl. CPC F24F 3/167; E04B 1/3449

(57) ABSTRACT

The invention relates to a cleanroom and a method for rapidly providing a cleanroom, having a first shell wall, which separates a first space that is indirectly or directly adjacent to a floor area, having a flexibly foldable shell wall directly facing the first space, which is made exclusively of at least one air-permeable material suitable for cleanrooms, from a second space surrounding the shell wall, and comprises at least one support element supported on at least one of the floor areas and at least one hanging element provided on the shell wall, having a mobile fan-filter unit, which has an air inlet area and an air outlet area and is outside the first space, and a supply line comprising a material for cleanrooms and connecting the air outlet area to the first space bounded by the shell wall arrangement.

### CROSS-REFERENCE TO RELATED APPLICATIONS

Reference is made to PCT/EP2023/068010 filed Jun. 30, 2023, and German Application No. 10 2022 116 468.3, filed Jul. 1, 2022, which are incorporated herein by reference in their entirety.

### BACKGROUND OF THE INVENTION

### Field of the Invention

The invention relates to a cleanroom arrangement and a method for rapidly providing a cleanroom, having a first shell wall arrangement, which separates a first space that is indirectly or directly adjacent to a floor area, having a flexibly foldable shell wall directly facing the first space, which is made exclusively of at least one air-permeable material suitable for cleanrooms, from a second space surrounding the shell wall arrangement, and comprises at least one support element supported on at least one of the floor area and at least one hanging arrangement provided on the shell wall, having a mobile fan-filter unit (FVE), which has an air inlet area and an air outlet area and is arranged outside the first space, and a supply line made from material suitable for cleanrooms and connecting the air outlet area to the first space bounded by the shell wall arrangement.

### Description of the Prior Art

The term “(ultra) cleanroom” describes a space that is closed off from an environment, in which the concentration of airborne particles is kept as low as possible depending on processes or activities that are to be carried out inside the space. Cleanrooms are widely used in semiconductor manufacturing, in optical and laser technology, the biosciences, medical research and even in aerospace engineering to name but a few application areas.

Aside from the aspect of the concentration of airborne particles, which can result in undesirable contamination of technical surfaces, especially in application areas where chemically sensitive and also microbiologically sensitive activities are carried out, it is important to implement measures to prevent at least one of chemical and microbiological contaminants within a defined spatial area.

Clean and ultra-cleanrooms are usually spaces of complex and technically elaborate design, to which access is gained most often through various airlock systems. Cleanrooms are supplied with specially fabricated air conditioning plants which ensure that contaminants are removed from the air immediately. For this purpose, a correspondingly filtered displacement flow is introduced into the cleanroom with the objective of guaranteeing the purity of the air inside it by virtue of a high air flow. All surfaces facing towards the cleanroom and also objects inside the cleanroom, are subject to cleanroom-specific requirements with the purpose of preventing air contaminations by gas volatilizations, particle liberations or similar processes that contaminate the cleanroom air. Since humans are generally the biggest source of particle releases, appropriate workwear, special working equipment and tools help to preserve the cleanroom quality that must be maintained inside the cleanroom, which is defined in standardized cleanroom classes. Thus, for example, this purpose is served with work clothing made from specially lint-free materials, hoods, shoe protectors etc.

Ultra-cleanrooms, such as those needed in semiconductor microelectronics, aerospace engineering, etc., are normally large-scale, complex infrastructures and rely on powerful ventilation and filter systems for a controlled supply of pure air, these systems usually being accommodated in neighbouring building areas.

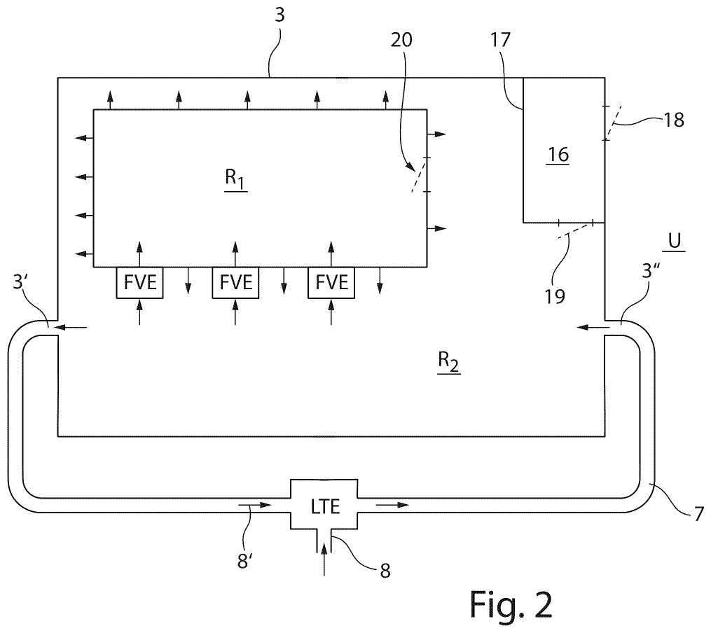

For the operation of a cleanroom, particle measurements are taken for purposes of classification and quality inspection, so that the cleanliness of the room can be classified. Accordingly, in the German industrial standard DIN EN ISO 14644-1 of August 2015, a division into nine different cleanliness classes ISO 1 to ISO 9 is set forth, which classes are illustrated in the table shown in FIG. 2a. For example, a cleanroom of cleanroom class 7 must not contain more than 352000 particles with a diameter greater than or equal to 0.5 μm, not more than 83200 particles with a diameter greater than or equal to 1 μm, and not more than 2930 particles with a diameter greater than or equal to 5 μm, per cubic meter in each case. In the table illustrated in FIG. 2a, the smaller the cleanroom class number is, the more stringent the cleanliness requirements become. Thus, a cleanroom in cleanroom class ISO 1 must not contain more than just 10 particles with a particle diameter greater than or equal to 0.1 μm and not more than 2 particles with a particle diameter greater than or equal to 0.2 μm per cubic meter.

Corresponding cleanroom quality requirements per cubic meter of air with regard to microorganisms significant for food are regulated in guideline series VDI 2083. A standardized number of colony-forming units (CFU) that is applicable for pharmaceutical cleanroom applications is regulated in the cleanroom classification according to the EU-GMP Guideline Annex 1; more detailed information about this appears in FIG. 2b. The room classifications are divided into GMP classes A to D and specify the respective maximum number of particles per pro cubic meter with corresponding particle sizes.

DE 36 21 452 A1 describes a typical cleanroom which offers a high degree of cleanliness for semiconductor manufacturing, wherein the various work areas are divided by partition walls, while spaces with work areas that need a high level of cleanliness are designed in the form of laminar boundary layer flow systems. The structure and arrangement of typical cleanroom areas illustrates the technological implementation effort that must be undertaken with cleanrooms in the form of immobile installations.

On the other hand, if none of the cleanroom requirements described above are needed in order to isolate room areas form the environment, many different solutions are known that use a tent-like construction to isolate specially conditioned room areas from a surrounding environment.

DE 198 36 896 A1 discloses an air-conditioned canopy for a baby that forms a tent-like superstructure over a room area, in which for example a baby's cot is placed, and which can be air-conditioned in terms of temperature and air humidity with the aid of an air conditioning unit.

A comparable arrangement for creating a therapeutic oxygen tent, which encloses a cube-shaped volume by use of an oxygen-impermeable shell wall, wherein pure oxygen is introduced into the interior of the volume through the shell wall, is described in U.S. Pat. No. 2,664,890.

US published patent application 2014/0148089 A1 describes a dust protection device, which is arranged around an object to be protected from contamination that is located on a moving platform. Essentially, it is a cubic strut construction that is placed around the object and whose side wall elements are constructed in the form of roller blind-like curtains. A fan unit with four air ducts, each of which opens into the side walls, is attached to the ceiling area of the strut structure. The supply air flowing out of the air ducts passes through the side wall elements, each of which has three plies, whereby the supply air is filtered and carries less dust when it reaches the dust-protected inner volume surrounded by the side wall elements. Excess air can escape into the environment through corresponding appropriate gaps both vertically between the adjacently aligned roller blind walls and in the bottom area of the protective device.

EP 0 224 505 B1 discloses an isolator for surgery for creating an atmosphere free of contaminants. This has in particular a compressed air-supported shell which is fed with filtered air via a fan with the air exiting the chamber again via an outlet. The chamber further has an upper viewing window, through which a surgeon can view the interior of the chamber from the outside. The chamber serves as a sterile room in which, for example, surgical procedures can be carried out. Preferably, a multiplicity of “sleeves” are attached to the chamber in a fluid-tight manner and allow an operator to access and reach into the interior of the chamber.

DE 603 07 945 T2 discloses a carrier air structure which can be air conditioned and surrounds a room with wall and ceiling sections that include air cells, and which are subject to an active air flow and which the room is air-conditioned with the aid of the air flow via openings in the air cells.

EP 2 601 927 B1 discloses a ventilation device for cleanrooms, which is mounted on to the ceiling in a cleanroom and includes a multiplicity of air supply chambers extending parallel to each other and through which air flows with the cylindrical shape being stabilized by air pressure.

EP 1 229 187 A1 describes an inflatable tent whose outer skin is fastened to a support frame.

US published patent application 2005/212415 A1 discloses an air treatment device for decontamination, air treatment and heating of an air stream which is obtained from the ambient air and can preferably be used as a supply air stream for ventilating or filling a tent arrangement.

US published patent application 2002/0083653 A1 describes an inflatable tent arrangement with an airtight tent wall, the tent wall support structures of which can be erected in a very short time using compressed air. The inside of the tent can be supplied with fresh air, which may optionally be purified, with the aid of a ventilation device.

US published patent application 2004/0261324 A1 discloses a tent for protection from at least one of biological and chemical contamination in the environment. For this purpose, the protective tent has a transparent plastic tent wall, with an air supply that opens into the floor area thereof, and which is connected to a suitable supply air device.

CA 2 172 929 A1 describes a portable shell arrangement for enclosing a room area, in which an overpressure relative to the environment is generated by a fan-driven supply air flow. An allergen filter installed in the supply air flow prevents contamination of the room area through the supply air flow.

U.S. Pat. No. 5,726,426 A discloses an enclosure supported by a rigid structure, through which purified air is passed into the room area delimited by the enclosure by use of a supply air device.

WO 2017/102568 A1 discloses a mobile cleanroom arrangement comprising a room with a dome-shaped, tent-like shell wall arrangement which has a flexible, foldable shell wall that directly faces the room and which is made exclusively from at least one material suitable for cleanrooms, as well as at least one of a support element braced on the floor area and at least one suspension means provided on the shell wall. At least a section of the shell wall is spaced a distance from the floor area or has at least one opening in the shell wall indirectly or directly adjacent to the floor area which allows the controlled outflow of air from the room area into the environment. A mobile filter-fan unit produces ultrapure air from ambient air, which flows into the room via a supply line made of material suitable for cleanrooms through the upper area of the shell wall in such a way that a vertically downwardly directed flow of pure air is formed within the room, which flows out of the room in a controlled manner close to the floor area.

### SUMMARY OF THE INVENTION

Based on the prior art cited above according to WO 2017/102568 A1, the invention addresses providing a cleanroom arrangement that creates a cleanroom atmosphere that is both particle-free and dry, and which may be provided as quickly, flexibly and cost-effectively as possible. In particular, the greatest attention is paid to avoiding and eliminating the atmospheric humidity present in conventional cleanrooms, which is particularly disadvantageous in battery production, semiconductor production, the development and manufacture of highly sensitive technical surfaces, such as in satellite technology and much more. Since the need and demand for such highly sensitive products is significantly greater than the existing production capacities, it is important to satisfy the associated production technology requirements and to make dry and particle-free cleanroom conditions available quickly and inexpensively, so that they can be implemented as widely as possible.

The problem addressed by the invention is a method for producing a cleanroom rapidly. Features that advantageously involve the invention, in particular describes with reference to the exemplary embodiments.

The cleanroom arrangement according to the invention uses the mobile cleanroom arrangement disclosed above in WO 2017/102568 A1, which provides a first shell wall arrangement that delimits a first space with a flexibly foldable shell wall that is indirectly or directly adjacent to a floor area, and at least one support element which is at least one of supported on the floor area and at least one hanging device provided on the shell wall. In order to avoid the release of particles into the first space from the shell wall, the shell wall is made from at least one air-permeable, material suitable for use in cleanrooms. In addition, a mobile filter-fan unit (abbreviated to FVE) is provided, which has an air inlet area and an air outlet area arranged outside the first space. A supply line made of material suitable for use in cleanrooms serves to feed in pure or ultra-pure air that can be produced with the FVE, which provides a fluid connection between the air outlet area of the FVE and the first space bounded by the shell wall arrangement.

In a further development of this known cleanroom arrangement, the cleanroom arrangement according to the invention has a second shell wall arrangement, which encloses the first shell wall arrangement together with a second space that surrounds the first shell wall arrangement and the FVE arranged therein with a flexibly foldable shell wall, which is made exclusively from at least one material that is diffusion-proof against moisture. The shell wall, which is diffusion-proof against moisture, in effect indirectly or directly borders the shell wall of the first shell wall arrangement, which is made of material suitable for cleanrooms, on the floor area, and isolates the interior of the second shell wall arrangement, that is the first and second spaces, from the external atmospheric environment. Like the first shell wall arrangement, the second shell wall arrangement has at least one of a support element which is supported on the floor area and at least one hanging device provided on the second shell wall. In this way, the second shell wall forms an independently self-supporting structural unit that is spatially separate from the first shell wall.

Finally, a mobile air drying unit (abbreviated to LTE) is provided, having an air inlet opening into the environment and an air outlet opening into the second space surrounded by the second shell wall. The LTE is preferably placed in the environment next to the second shell wall.

The operating principle underlying the cleanroom according to the invention creates a dry atmosphere inside the second space enclosed by the shell wall, preferably with a degree of dryness that can be described by the dewpoint temperature, which is in the range between −30° C. and −70° C., that is the residual moisture contained in the second space only begins to condense at the very low dewpoint temperatures. With the exception of the low residual moisture, the air fed into the second space by the LTE has substantially the same particulate composition as the ambient air.

Due to the shell wall, which is diffusion-proof against moisture and whose water vapor permeability as defined in DIN 53 122-2 preferably less than 0.1 g H₂O/(m²×24 h), from which the second shell wall arrangement is made, no moisture components can get into the second space, thereby ensuring the formation of a dry atmosphere inside the second space which is permanently stable.

In a subsequent step, the dried ambient air is sucked in by the FVE located inside the second space and pure or ultrapure air depending on requirements is generated using appropriate filtering, which air is fed into the first room space surrounded first shell wall arrangement via a supply line.

In order to be able to guarantee the user-specific cleanliness requirements inside the first space, both the supply line between the FVE and the first space as well as the shell wall surrounding the first space are made from material suitable for cleanrooms, which complies with the cleanliness conditions of ISO classes 1 to 9 depending on requirements as defined in ISO 14644-1.

Because of the flexible and mobile design of the first and second shell wall, the cleanroom according to the invention can be set up quickly and easily, and therefore can also be produced inexpensively. Accordingly, the first shell wall arrangement is set up in a suitable location, similarly to the erection of a tent construction or an inherently stable or self-supporting inflatable wall construction that encloses the first room.

The second shell wall is then set up in such a way that it surrounds the first shell wall without contact, and together therewith delimits an intermediate space, the “second space”. Subsequently, air from the environment immediately surrounding the second shell wall is dried, and the dried ambient air is fed into the second space. In this way, a dry, particle-charged atmosphere is created inside the second space. This ambient air, which has been dried inside the second space, is used in a second step to purify it and subsequently feed it into the first space, that is the cleanroom, in the form of purified, dry pure or ultra-pure air.

The ambient air is preferably dried by sorption-assisted condensation to obtain a dried ambient air which has a dewpoint between −30° C. and −70° C. and is subsequently fed into the second space in controlled manner continuously or intermittently through the second shell wall arrangement, so that a pressure p2 is produced inside the second space that is greater than the ambient pressure p3.

The dried ambient air located in the second space is extracted by an FVE and filtered by a single or multiple filtering to obtain purified dry air, which is subsequently fed into the first space through the first shell wall in such a way that a pressure p1 is produced inside the first space which is greater than the pressure p2 in the second space. The creation of such a pressure gradient from the first space via the second space into the environment ensures that no material flows of any kind can pass through the shell walls from the outside to the inside, even in the event of local damage to the shell wall. This guarantees permanently particle-free and dry air quality inside the first room.

In principle, the cleanroom according to the invention is suitable for any production and research areas with requirements for low atmospheric humidity and high air purity. Typical industries for using such cleanroom arrangements are automotive, mobile phones with the battery production therefor and corresponding research, as well as space flight with production and testing of satellites. The cleanroom according to the invention is also suitable for use in areas such as optics, life sciences, biochemistry, bioinformatics, biology, biomedicine, bioliquids, bio-and genetic engineering, nutritional sciences, food technology, medicine, medical engineering, pharmacy and pharmacology, environment management and environmental engineering, chemistry, automobile, microsystems technology, semiconductor technology, automation technology and energy sector.

The advantages of the cleanroom according to the invention compared to classic dry cleanrooms are found in significantly faster readiness, significantly lower construction costs with the same or higher qualities in terms of dryness and purity when producing a dry, ultra-pure air atmosphere inside the cleanroom.

The decoupling of dryness and purity according to the invention by creating two rooms that are isolated from the environment also offers a further technological advantage in terms of the ability to use the dry atmosphere again in the second space.

In order to achieve additional thermal decoupling from the environment, a further embodiment provides for an at least double-walled design of the second shell wall, in which both shell walls delimit an intermediate space with an internally mounted support structure, in which negative pressure conditions also prevail in order to reduce thermal conductivity and thereby enable thermal decoupling.

Since the need for quickly available dry cleanroom area and dry cleanrooms is enormous and will continue to increase, there is high economic potential associated with closing this existing gap in demand.

### BRIEF DESCRIPTION OF THE INVENTION

In the following text, the invention will be described for exemplary purposes without limitation of the general inventive thought, using an embodiment thereof and with reference to the drawing. In the drawing:

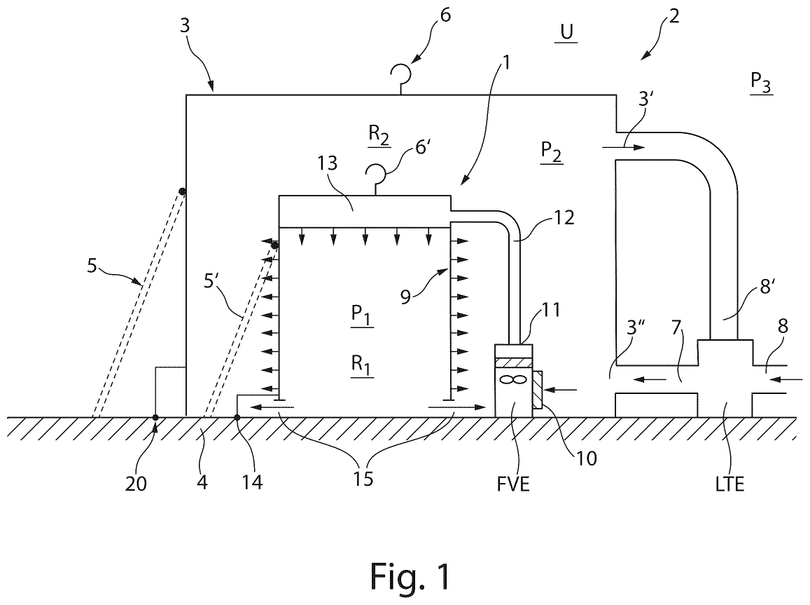

FIG. 1 is a schematic representation of a cleanroom arrangement according to the invention;

FIG. 2 is a plan view of a cleanroom arrangement according to the invention;

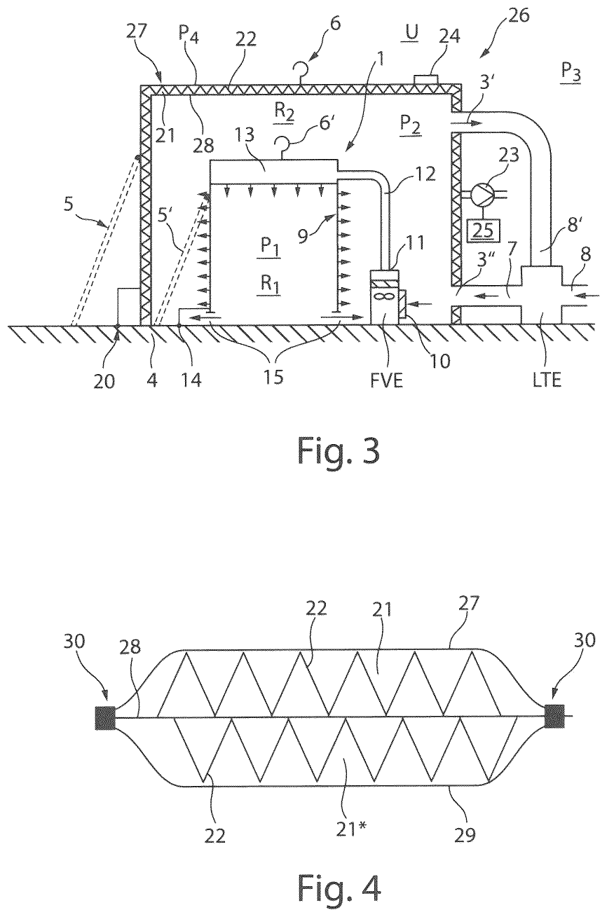

FIG. 3 is a schematic representation of a cleanroom arrangement according to the invention with a double-wall second shell wall arrangement;

FIG. 4 is a multi-ply design of the second shell wall arrangement; and

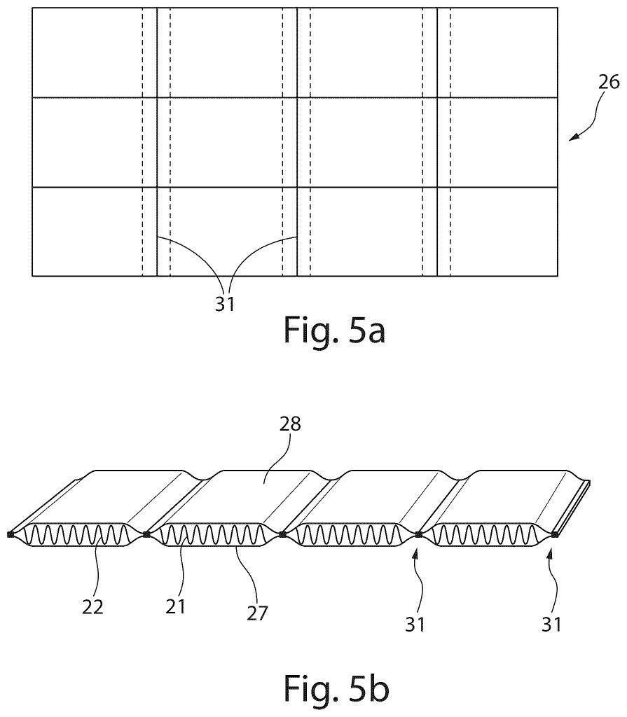

FIGS. 5a, b are a further variant to the design of the second shell wall arrangement.

### DETAILED DESCRIPTION OF THE INVENTION

FIG. 1 shows a cleanroom arrangement assembled from two separate shell walls 1, 2.

The second, outer shell wall 2 has a flexibly foldable and tent-like shell wall 3, which isolates an inner intermediate space, the “second space” R2, from the outside, that is from the environment U. The shell wall 3 of the second shell wall 2 is a diffusion-proof material that is diffusion-proof to moisture. The diffusion-proof material, which preferably is a plastic film, has a water vapor permeability defined by DIN 53 122-2 which is preferably less than 0.1 g H₂O/(m²×24 h). The high-density shell wall 3 is preferably made from a plastic film, with at least one side of which being metallized. Optionally, the plastic film, which is metallized on at least on one side, comprises two or more plies, wherein a first ply has a different property from a second layer. In one variant, the shell wall 3 includes at least three plies, the shell wall 3 having at least one ply made of a metal, such as aluminium, copper, zinc, etc. The shell wall 3 is for example a pouch film,. Alternatively, the shell wall 3 comprises at least one plastic film, with at least a part being coated with a metal.

The shell wall 3 is otherwise completely closed except for doors, windows or media feedthroughs (not shown) that are optionally incorporated in the shell wall 3. For an inherently stable structure of the second shell wall 2, at least one support element 5 supported on at least one of the floor region 4 and at least one hanging arrangement 6 is provided on the second shell wall 3.

The second space R2 includes an air inlet 3″ and an air outlet 3′. The air inlet 3″ is connected to the air outlet of an air drying unit LTE, which is outside the second space R2 in the atmospheric environment U, via an air line 7. The air drying unit LTE can suck in atmospheric ambient air via its air inlet 8, dry it and feed it into the second space R2 as dried ambient air via the air line 7. Like the shell wall 3, the supply line 7 is also made of a material that is diffusion-proof against moisture.

Moreover, an air outlet 3′ is provided on the shell wall 3, preferably on a region of the shell wall that is spaced from the dry air feed into the outer shell wall 2, which is connected to a further air inlet 8′ of the LTE via an outlet. In this way, a quasi-closed dry air circuit is created with regard to the dry air feed into and out of the second space R2, in order to reach the degree of drying inside the second space R2 quickly and to keep it stable permanently with the lowest possible energy expenditure. The dry air circuit closed in this way is only virtually closed due to the additional supply or feed of dried supply air from the atmospheric environment via the air inlet 8 of the LTE. If necessary, the quantities of air that are supplied to the LTE through air inlets 8, 8′ can be controlled and synchronized with each other.

The LTE air drying unit is a standard industrial air treatment unit for drying, which dries the supply air from the environment U by condensation, optionally supported by sorption, to such a degree of dryness that the dried supply air fed to the second space R2 has a dewpoint between −20° C. and −80° C. In this way, a dry but particle-charged air atmosphere forms inside the second space R2, which also has an overpressure p2 that exceeds the ambient pressure p3.

A further shell, the “first shell” 1, is arranged inside the second shell wall 2, separately and at a distance therefrom, and has an effectively flexibly foldable shell wall 9 which directly faces the inner first space R1, but which, unlike the shell wall 3, is not diffusion-proof, but has an air-permeable, cleanroom-compatible material which on the one hand, has little or no intrinsic emission behavior of particles and fibers and, on the other hand, allows the possibility of air throughflow.

For the purpose of producing a dry cleanroom atmosphere inside the first space R1, a filter fan unit FVE is mounted inside the second space R2, the dried ambient air contained in the second space R2 is sucked in via its air inlet area 10, and is purified inside the filter fan unit FVE and fed into the first space R1 through the shell wall 9 of the first shell wall arrangement 1 via its air outlet area 11 and a supply line 12 connected thereto. The air inlet area 10 of the FVE is preferably arranged close to the location of the dry air feed to the second space R2. The degree of purity of the dried pure air fed into the first space R1 can be selected depending on requirements and preferably corresponds to the cleanliness classes prescribed in the ISO classes 1 to 9 specified in DIN EN ISO 14644-1. In order to be able to maintain the cleanliness classes defined there in the first spatial area R1 reliably and invariably for as long as possible, both the shell wall 9 and the supply line 12 that connects the air outlet region 11 of the filter fan FVE to the first shell wall arrangement 1, are made of material suitable for cleanrooms that complies with the norms DIN EN ISO 14644-14 and DIN EN ISO 14644-15.

The dried pure or ultra-pure air is fed into the first space R1 via an air duct plenum 13 mounted in the ceiling area of the first shell wall 1. The air duct plenum 13 introduces the pure dry or ultra-pure air vertically downwards in the direction of the floor area 4 by use of suitable air guides. The vertically downwardly directed distribution of the air preferably takes place over the widest possible area with the help of the air duct plenum 13. That is the vertically downward air outflow takes place over the entire outflow area of the air duct plenum 13 which opens vertically downwards.

The air duct plenum 13 is airtight or almost airtight except for the downward outflow area into the first space R1.

Like the second shell wall 2, the first shell wall 1 also forms a self-supporting, independent and separate structural unit, and itself has at least one of either a support structure 5′ supported on the floor area 4 or at least one hanging arrangement 6′ attached to the shell wall 9.

In order to minimize electrostatic fields and charges, the shell wall 9 of the first shell wall 1 is electrostatically conductive and is connected to ground via a grounding point 14. In the same way, in order to minimize electrostatic fields or charges in the diffusion-proof shell wall 3 this is also designed to be electrostatically conductive and is connected to ground via a grounding point 20.

Like the second shell wall 2, the shell wall 9 of the first shell wall 1 also provides at least one door for entering the first space R1. Optionally, windows or other media passthroughs may be integrated within the shell wall 9, but these are not shown in FIG. 1.

In order to displace the pure or ultra-pure air from the first space R1 and into the second space R2, the entire area of the shell wall 9 of the first shell wall 1 is made from air-permable fabric material suitable for cleanrooms, that is due to an overpressure p1 created in the first space R1 compared to the pressure p2 in the second space R2, dry pure air flows over the entire expanse through the shell wall 9 into the second space R2. In addition, the shell wall 9 preferably has at least one opening 15 in the area close to the floor, preferably as a circumferential floor gap, through which the major part of the dry clean air directed from the first space R1 into the second space R2 can escape, as shown by the air flow arrows there. The air thus circulates between the two spaces R2 and R1, with static pressure ratios p1, p2 with respect to the ambient pressure p3 being established in such a way that p1>p2>p3. This ensures that, firstly, neither atmospheric humidity nor particle contamination can get into or occur in the first space R1, and secondly, that any person, machine, or process-related moisture and particles carried into the first space R1 can be selectively discharged into the second space R2 from the first space R1. The continuous air flow through the first space R1 with the associated continuous air filtering with the aid of the filter fan unit FVE as well as the continuous or intermittent feed of dry air into the second space R2 by means of the air drying unit LTE guarantees that a dry cleanroom atmosphere inside the first space R1 is established and maintained.

FIG. 2 shows a schematic plan view of a further embodiment of the cleanroom arrangement according to the invention. The diffusion-proof shell wall 3 separates the second space R2 from the atmospheric environment U. A dry lock chamber 16 which is delimited by both the shell wall 3 and a chamber wall 17, is immediately adjacent to the shell wall 3. Access from the atmospheric environment into the dry lock chamber 16 is possible via a first lock door 18 installed in the shell wall 3. Access between the second space R2 and the dry lock chamber 16 is possible via a second lock door 19 installed in the chamber wall 17.

In the case shown in FIG. 2, the LTE feeds dried supply air into the second space R2 via the supply line 7 through the air inlet 3″. The air outlet 3′ is provided on the shell wall opposite the feed point 3″ and is connected to the further air inlet 8′ of the LTE via a supply line. The LTE also provides an air inlet 8 for sucking in atmospheric ambient air. Depending on requirements, the air quantities supplied via the air inlets 8, 8′ of the LTE can be adjusted in a controlled, coordinated manner. For example, if necessary, the atmospheric supply air via the air inlet 8 can be blocked completely so that the supply air feed and air removal into and out of the second space R2 is circulated in a completely closed air circuit.

The first shell wall arrangement 1, whose air-permeable shell wall 9 separates the first space R1 from the second space R2, is located inside the second space R2. Several FVEs are used to feed dried pure or ultra-pure air from the second space R2 into the first space R1 to enable the strongest possible feed of dry air-pure air into the first room R1.

The cleanroom arrangement illustrated in FIG. 1 is particularly suitable for any production and research areas with requirements for both low humidity and high purity. Typical industries for such use are automotive, mobile phone manufacture as well as battery production and battery research therefor, space flight, especially the production and testing of satellites.

FIG. 3 shows a modification or addition to the cleanroom illustrated in FIG. 1; in this case, unlike the situation represented in FIG. 1, the second shell wall arrangement 26 is not made of only one high-density shell wall 3 a moisture diffusion-proof material, but from a two flexibly foldable moisture diffusion-proof second shell walls 27, 28, each of which delimits an intermediate space 21, inside which a support structure 22 keeps the two second shell walls 27, 28 apart and through which air can flow in the longitudinal direction of the shell wall. The intermediate space 21 is surrounded in a fluid-tight manner by the two second shell walls 27, 28 thereby creating an additional thermal barrier function with respect to the environment U. Particularly when negative pressure is applied inside the intermediate space 21, the double-walled second shell wall 26 functions as a thermal insulating layer in addition to the moisture diffusion-proof quality according to invention as explained earlier. The negative pressure inside the intermediate space 21 may be achieved by aspirating once and then hermetically sealing the intermediate space 21 or, as shown as an option in FIG. 3, with a fluid-tight connection to a negative pressure source 23. The negative pressure source 23 may be operated continuously, or with open-or closed-loop control to ensure actively monitored negative pressure P4 within the intermediate space 21.

In an advantageous embodiment, a sensor unit 24 is arranged on or in the second shell wall 26 in order to detect a pressure P4 prevailing in the intermediate space 21 and to generate a sensor signal which is dependent on the pressure P4 and which serves as an open or closed loop control variable for a regulation or control unit 25, which regulates or controls the negative pressure source 23 accordingly.

All other components shown in FIG. 3 are already provided with the reference numbers that have already been explained in connection with FIG. 1, so it is not necessary to explain them again at this point.

FIG. 4 shows a further alternative embodiment for a thermally insulating second shell wall 26, which has three flexibly foldable second shell walls 27, 28, 29, each of which includes two intermediate spaces 21, 21*, in each of which a support structure 22 allowing throughflow is introduced to keep the respective second shell walls 27, 28, 29 spaced apart from each other so that they can support mechanical loads. In the exemplary embodiment as shown, each of the second shell walls 27, 28, 29 are connected 30 in a fluid-tight manner at the ends and each hermetically seal the inner space 21, 21 *. Negative pressure conditions prevail inside the intermediate spaces 21, 21*, so that the shell wall arrangement 2 shown schematically in FIG. 4 has thermally insulating properties.

FIG. 5a shows a plan view of a further embodiment of a thermally insulating second shell wall arrangement 26 and FIG. 5b shows a cross section through the corresponding shell wall 26. In the case of FIG. 5b. the second shell wall 26 has two diffusion-proof shell walls 27, 28 arranged at a distance from each other, each of which delimits an intermediate space 21, within which a support structure 22 is introduced. For reasons of stability and to allow the second shell wall 26 to have the largest possible area, both second shell walls 27, 28 are joined together by array-like connecting regions 26 in the form of corrugations or the like which first reduce the surface load acting on the support structure 22 due to the negative pressure and particularly create a large-expanse second shell wall 26 and second, also helps improve the self-supporting capability of the flat shell wall.

The cleanroom arrangement according to the invention enables rapid and cost-effective availability, also with low construction costs for the same or higher quality in terms of providing a dry cleanroom. The decoupling for the generation of dry air and dry, pure air ensures a high level of robustness and reliability during operation of the cleanroom arrangement according to the solution.

### LIST OF REFERENCE NUMERALS

1 First shell wall arrangement
2 Second shell wall arrangement
3 Shell wall, outside
3′ Air outlet
3″ Air inlet
4 Floor area
5 Support element
5′ Support element
6 Hanging arrangement
6′ Hanging arrangement
7 Air outlet
8 Air inlet
8′ Further air inlet
9 Shell wall, inside
10 Air inlet area
11 Air outlet area
12 Supply line
13 Air duct plenum
14 Grounding point inside of shell wall
15 Opening
16 Dry lock chamber
17 Chamber wall
18 First lock door
19 Second lock door
20 Grounding point outside of shell wall
21, 21* Intermediate space
22 Support structure allowing flowthrough
23 Negative pressure source
24 Sensor unit
25 Open or closed loop control
26 Second shell wall
27, 28, 29 Second shell walls
30 Hermetic closure
P1,P2,P3,P4 Pressure values
R1 First space
R2 Second space
U Environment

1-26. (canceled)

27. A cleanroom comprising:
a first shell wall separating a first space adjacent to at least one floor area, a flexibly foldable shell wall directly facing the first space made exclusively of at least one air-permeable material for use in cleanrooms, a second space surrounding the first shell wall, comprising at least one support element supported on the at least one floor area and at least one arrangement hanging on the shell wall;
a mobile fan-filter unit (FVE) including an air inlet area and an air outlet area which is located outside the first space;
a supply line comprising a material suitable for cleanrooms which connects the air outlet area to the first space which is bounded by the first shell wall; and
a second shell wall surrounding the first shell wall together and the FVE which is within the second space;
a flexibly foldable second shell wall made exclusively of only at least one material that is diffusion-proof against moisture which separates the foldable second shell wall from an environment surrounding the second shell wall which includes at least one support element supported on at least one of the at least one floor area and at least one arrangement having on the second shell wall; and
that mobile air dryer has an air inlet, opens into the environment and an air outlet which opens into the second space.

28. The cleanroom according to claim 27, wherein:
the at least one air-permeable material suitable for cleanrooms directly delimits a cleanroom of ISO classes 1 to 9 as defined in DIN EN ISO 14644-1, and the FVE produces ultrapure air from ambient air in accordance with the DIN EN ISO 14644-1.

29. The cleanroom according to claim 27, wherein:
the at least one air-permeable material suitable for cleanrooms is a textile having a flow permeability in the range from 500 to 9000 m³/m²h.

30. The cleanroom according to claim 28, wherein:
the at least one air-permeable material suitable for cleanrooms is a textile having a flow permeability in the range from 500 to 9000 m³/m²h

31. The cleanroom according to claim 29, wherein:
the second shell wall is diffusion-proof against moisture and has a water vapor permeability as defined in DIN 53 122-2 to be less than 0.1 g H₂O/(m²×24 h).

32. The cleanroom according to claim 27, wherein:
the at least one air-permeable material that is diffusion proof against moisture is plastic, and the second shell wall includes at least one plastic film.

33. The cleanroom according to claim 32, wherein:
at least one side of the plastic film is coated with a metal layer.

34. The cleanroom according to claim 26, wherein:
an air inlet of a mobile air drying unit (FVE) feeds in atmospheric ambient air, and the FVE sucks the atmospheric ambient air in through the air inlet, dries the atmospheric air which is fed through the air outlet into the second space as drier air with a dewpoint between −20° C. and −80° C.

35. The cleanroom according to claim 34, wherein:
the FVE and LTE are synchronized so that a first pressure p1 is created inside the first space, and a second pressure p2 is created inside the second space; and
for p1 and p2: p1>p2>p3, wherein p3 corresponds to the atmospheric ambient pressure.

36. The cleanroom according to claim 34,
wherein the FVE is inside the second space and the LTE is in the environment.

37. The cleanroom according to claim 27, wherein:
the first shell wall has at least one door, which is only at least one material suitable for cleanrooms which directly faces the first space; and
the second shell wall includes at least diffusion-proof door.

38. The cleanroom according to claim 27, wherein:
the first and second shell walls are separated and statically independent, self-supporting structural units.

39. The cleanroom according to claim 27, comprising:
an air duct plenum within a ceiling area inside the first shell wall including the supply line and has an air guidance, via which dried, ultrapure air is introduced into the air duct plenum and directed to the at least one floor area.

40. The cleanroom according to claim 27, wherein:
the second shell wall comprises a dry lock chamber including at least two doors including at least a first door providing access between the dry lock chamber and the environment, and at least the second door provides access between the dry lock chamber and the first space.

41. The cleanroom according to claim 27, wherein:
the second shell wall includes at least two flexibly foldable second shell walls spaced from each other and which each bound an intermediate space, and a support structure and provide a flowthrough in a longitudinal direction of the shell wall which is located in the intermediate space which holds the two second shell walls apart.

42. The cleanroom according to claim 41, comprising:
a negative pressure source including a fluid tight connector in the intermediate space.

43. The cleanroom according to claim 42, comprising:
a sensor unit or in the second shell wall for detecting pressure existing inside the intermediate space and which generates a sensor signal depending on the detected pressure; and
an open or closed loop control which regulates or controls the negative pressure source coupled to based on the sensor signal.

44. The cleanroom according to claim 43, wherein:
a pressure within the intermediate space is lower than a pressure in the environment.

45. The cleanroom according to claim 44, wherein:
a pressure p4 in the intermediate space has a relationship: 10 Pa≤p4≤100,000 Pa.

46. The cleanroom according to claim 41, wherein:
the intermediate space is hermetically sealed.

47. The cleanroom according to claim 46, wherein:
negative pressure or atmospheric pressure exists in the intermediate space.

48. The cleanroom according to claim 41, wherein:
the at least two second shell walls comprise at least one material that is diffusion-proof to moisture.

49. A method for providing a cleanroom enclosing a first space in which dry cleanroom conditions prevail comprising steps of:
setting up a portable first shell wall surrounding the first space;
setting up a portable second shell wall surrounding the first shell wall which contactlessly and together bounds the second space;
drying ambient air from an environment adjoining the second shell wall and feeding the dried ambient air into the second space; and
purifying the dried ambient air from the second space and feeding the purified dried air into the first space.
